(19) United States
(12) Patent Application Publication
(10) Pub. No.: US 2007/0026725 A1
(43) Pub. Date: Feb. 1, 2007

(54) Connector

(76) Inventor: Hidehiro Shindo, Tokyo (JP)

Correspondence Address: HARRINGTON & SMITH, LLP, 4 RESEARCH DRIVE, SHELTON, CT, 06484-6212, US

(21) Appl. No.: 10/564,666

(22) PCT Filed: Jul. 16, 2004
(86) PCT No.: PCT/JP04/10201

§ 371 Date: May 11, 2006

(30) Foreign Application Priority Data
Jul. 17, 2003 (JP) 2003-276353

(51) Int. Cl. H01R 12/24

(52) U.S. Cl. 439/495

(57) ABSTRACT

An electrical connector having a first housing and a second housing is provided. The first housing has contact portions formed as separate bodies. One end of a contact portion is in contact with an anisotropic conductive film, the other end is in contact with a terminal in the second housing, and thus electrical connection is established. Also provided is a second connector, where the second housing is fixed to a circuit board and has contacts, and each contact is installed in an inverted relationship with adjacent contacts.

### TECHNICAL FIELD

The present invention relates to an electrical connector, particularly to a connector used for electrical connections of flat cables or the like.

### BACKGROUND ART

Conventionally, more compact and easily fitting structures are desired for electrical connectors, such as high-density arrangements of contacts or the like and ease of fitting. In particular, recent years have seen a demand for compact connectors capable of high-density arrangements of contacts in conjunction with the increased popularity of mobile devices exemplified by mobile phones and the like.

### DISCLOSURE OF THE INVENTION

Problems to be Solved by the Invention

However, past attempts to make connectors smaller have been restricted by such factors as the area occupied by the contacts, thus making it difficult to further miniaturize the compact connectors that are capable of being used in portable devices or the like.

Means for Solving the Problems

In consideration of the above-mentioned problems, the present invention offers an electrical connector consisting of a first housing and a second housing, said first housing having contact portions, achieving an electrical connection by one of the end portions of said contact portions contacting an anisotropic conductive film, and the other end portions contacting terminals provided on the second housing. Due to this structure, it is possible to achieve a reliable electrical connection for contacts disposed at high density.

Additionally, the invention offers a connector in which the aforementioned first housing has through holes for receiving the aforementioned contact portions that are separately formed, said through holes being positioned in a staggered fashion. Due to this structure, the separate contact portions are received in through holes of the first housing, and the through holes and contact portions can be formed smaller, so as to allow reliable electrical connections to be made between a cable and contacts disposed at high density. Furthermore, the through holes are positioned in a staggered fashion, thus allowing for a high-density arrangement of contacts.

A connector is offered in which the aforementioned first housing has a conductive shell, the aforementioned shell connected to a shield portion of a conductor contacting said anisotropic conductive film. The presence of this shell allows signal transmissions to be reliably performed even in environments wherein EMI or the like are present.

Furthermore, the first connector has recesses or bumps for fitting with a second connector, and these are protrusions or orifices for receiving such protrusions in order to prevent misfitting of the connectors. Additionally, the invention offers a second connector comprising a second housing affixed to a substrate, said second housing having contacts, and said contacts being oriented in a mutually inverted relationship with adjacent contacts. By orienting the contacts in mutually opposite directions, it is possible to achieve contact with the aforementioned contact portions that are arranged in a staggered fashion.

The connector is further such that the second connector has an engaging portion for engaging with the first connector on at least one end in the direction of insertion of the first connector. As a result, it is possible to prevent disengagements due to vibrations or the like.

### BRIEF DESCRIPTION OF THE DRAWINGS

FIG. 1: FIG. 1 is an exploded perspective view of a first connector according to the present invention.

FIG. 2: FIGS. 2(a) and (b) are perspective views of a first housing according to the present invention and a contact portion inserted into this housing.

FIG. 3: FIG. 3(a) is a drawing showing the present invention prior to fitting together the first connector and the second connector. (b) is a drawing showing them fitted together.

FIG. 4: FIG. 4 is a section view showing the first and second connectors fitted together.

FIG. 5: FIG. 5 is a section view of the state shown in FIG. 3(b).

### DESCRIPTION OF REFERENCE NUMBERS

1 cable
2 conductor of cable
3 first housing
4 conductive shell
5 first connector
6 engaging portion of first housing
7 engaging portion of conductive shell
8 second connector
9 engaging portion of second housing
10 projection of first housing
11 opening of second housing
12 contact portion
13 anisotropic conductive film
14 top surface of contact portion
15 bottom surface of contact portion
16 contact
18 through hole
19 positioning bump
20 positioning recess
21 second housing
22 shell engaging portion
23 shell engaging portion receiving portion
24 pressing member
25 contact portion engaging portion
26 top surface of housing

### BEST MODE FOR CARRYING OUT THE INVENTION

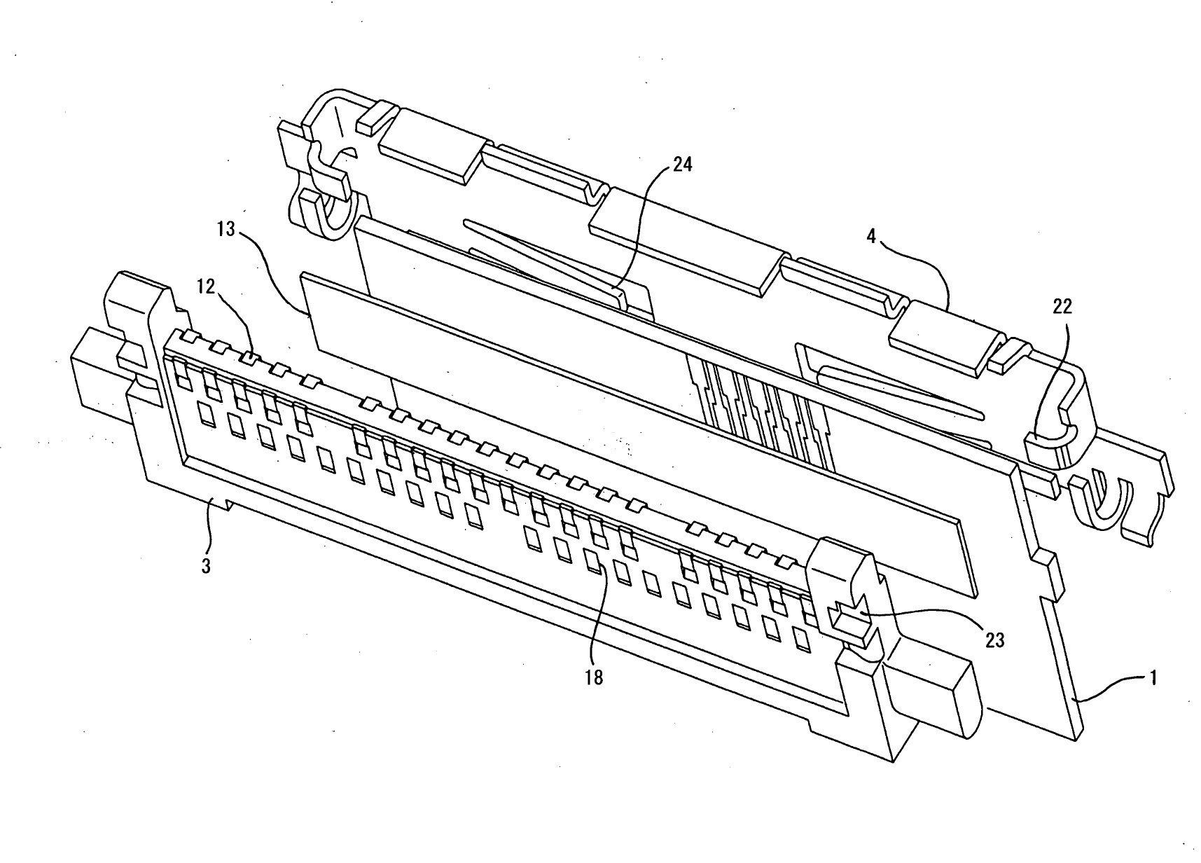

Embodiments of the present invention shall be described below. FIG. 1 is an exploded perspective view of a first connector of a connector according to the present invention. As shown in the drawing, a cable (1) such as an FPC or the like is connected to a first housing (3) via an anisotropic conductive film (13), and a conductive shell (4) is attached to the first housing (3) so as to cover the anisotropic conductive film (13) and cable (1). This anisotropic conductive film (13) can be affixed by applying an adhesive to one or both sides. Those skilled in the art will recognize that if the adhesive is to be applied to the entire surface of the film, the adhesive must be conductive. A pressing member (24) for pressing the cable (1) or the anisotropic conductive film (13) is formed on the conductive shell (4). Although the anisotropic film is insulating when no pressure is applied, when pressure is applied to the film, it becomes conductive in the direction of pressure. Therefore, an electrically conductive area will be formed on the film when the pressing member (24) presses against the cable (1) or the anisotropic conductive film (13). By using such an anisotropic conductive film, even when there is a slight shift in the relative positions of the cable (1) and the contact portions (12) in the vicinity of the terminal portions of the connectors, electrical communication will be possible as long as some of the anisotropic film (13) is present in this area. Due to this feature, the connector of the present invention can be made smaller by using such an anisotropic conductive film. Therefore, the present invention is effective even when the contacts must be formed at high density and the contact portions must be made small, thus requiring a high level of precision for the connection. Additionally, through holes (18) are formed in the first housing, and contact portions (12) are received in these through holes. Additionally, the areas around the opening portions of the through holes (18) are tapered, so as to allow for reliable positioning of the contacts when fitting them, and allowing the contacts to be brought smoothly into contact with the contact portions (12).

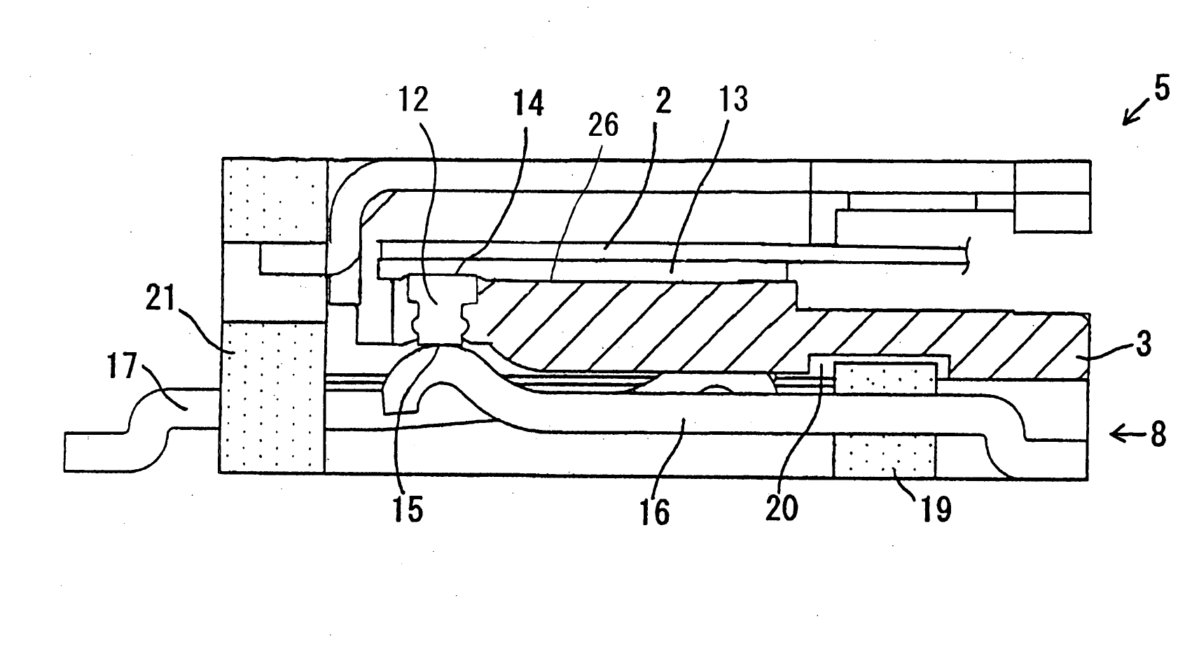

As seen in this drawing, the conductive shell (4) has a shell engaging portion (22) that engages with the first housing (3), and this shell engaging portion (22) engages with a shell engaging portion receiving portion (23) formed in the first housing (3). As a result, the conductive shell (4) is securely engaged to the first housing, and the pressing member (24) of the conductive shell is made to press against the cable (1) and the anisotropic film (13). At this time, the pressing member (24) generates enough pressure for the anisotropic conductive film (13) to exhibit conductivity. For example, as shown in FIG. 5, the top surface (14) of the contact portion (12) protrudes from the top surface (26) of the first housing, and the pressure of the pressing member (24) causes pressure to be applied between only the top surface (14) of the contact portion and the conductor (2) of the cable. As a result, this area is made conductive. On the other hand, not enough pressure is applied between the top surface (26) of the first housing and the conductor (2) of the cable to exhibit conductivity, and this area is therefore insulated. Consequently, an electrical connection is made only between the contact portion (12) and the conductor (2) of the cable.

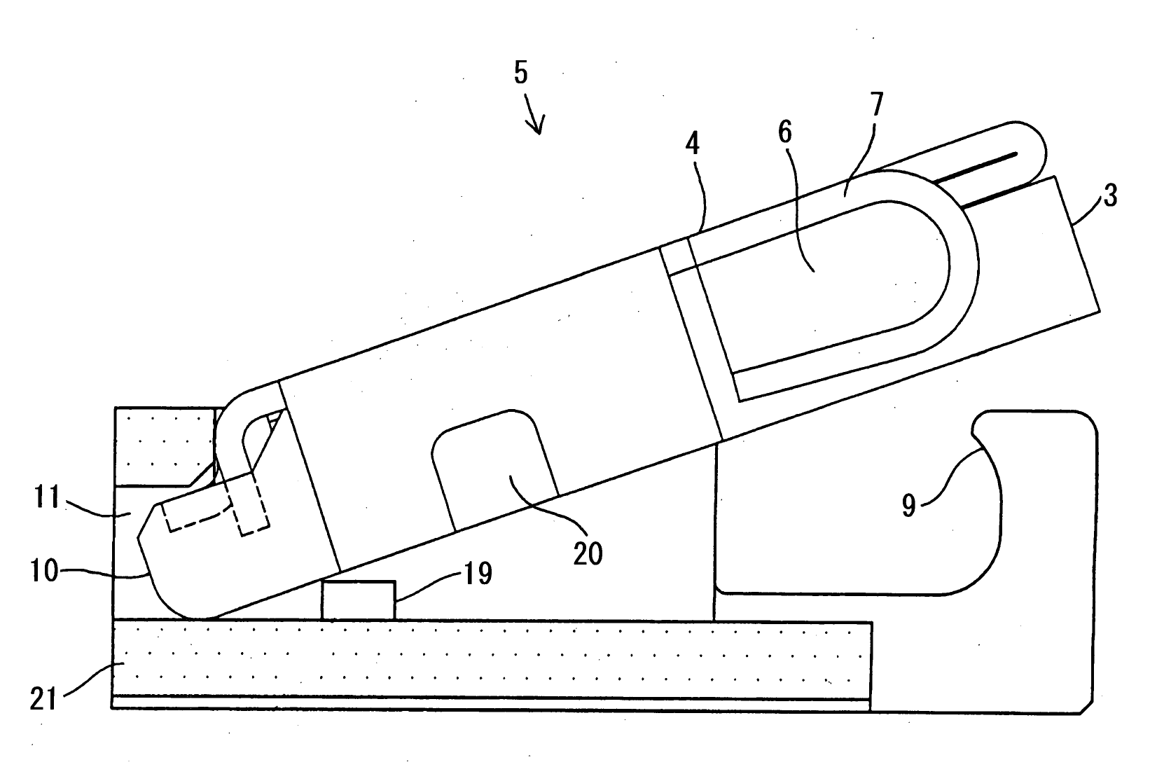

Next, the first housing and the contact portions housed in this housing shall be described. The connectors of the present invention have through holes for housing contact portions in the first housing, and electrically communicate the top surface and bottom surface of the housing. FIG. 2(a) shows a contact portion (12) and FIG. 2(b) shows a first housing (3). The contact portion (12) has a contract portion engaging portion (25) for engaging with the inner wall of a through hole (18) of the first housing when inserted into the through hole (18). The contact portion (12) is such that the length of the top surface side of the first housing, in other words, the side coming into contact with the conductors of the cable, is longer than the length of the bottom surface side, in other words the side contacting the contacts of the second housing. However, the shape of the contact portion (12) is not limited to such a shape. Through holes (18) of a size capable of receiving the contact portions (12) are positioned in staggered fashion on the first housing (3). Additionally, tapers are provided in the areas around the openings of the through holes (18) as described above. They do not need to be tapers and may be steps. These allow positioning of corresponding contacts when the connector is fitted.

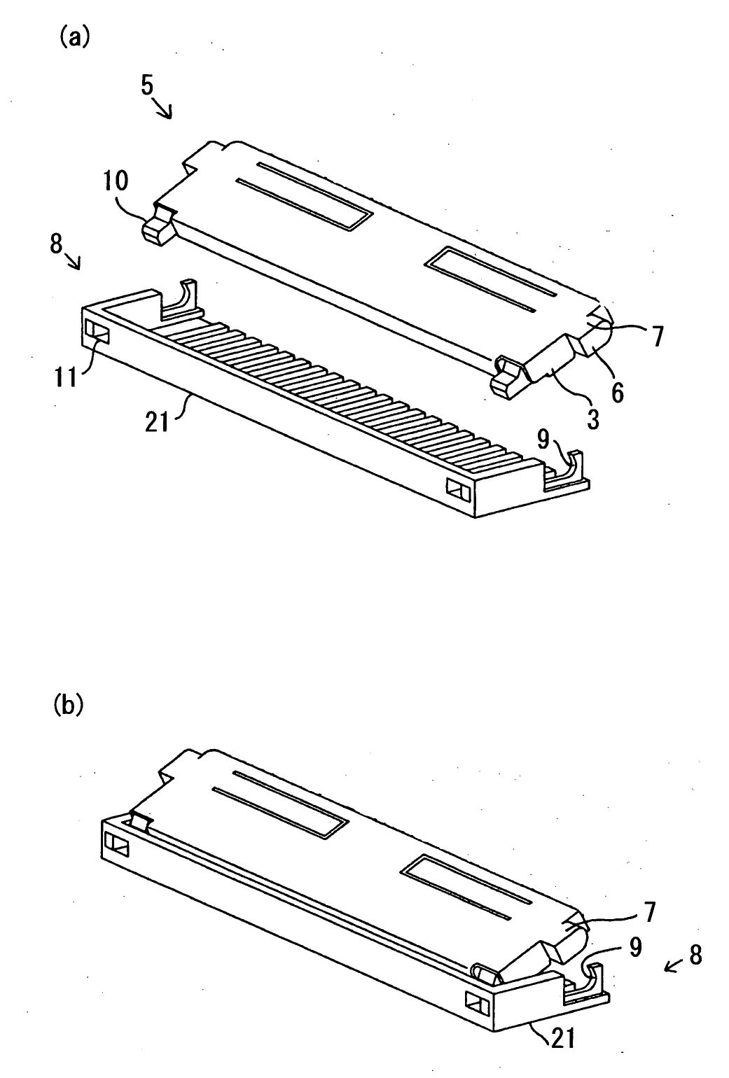

Next, the process of fitting the connectors shall be described. As shown in FIGS. 3(a) and (b), the first connector (5) is inserted into the second connector (8) from the side where the contacts are exposed. As shown in (a), a projection (10) of the first housing is inserted into a corresponding opening portion (11) in the second housing (21), then the first connector (5) is pushed into the second connector (8) and fitted. Furthermore, as shown in FIG. (b), the engaging portion (7) of the conductive shell (4) and the engaging portion (9) of the second housing are engaged. Additionally, the structure is such that when making the engagement, the engaging portion (9) of the second housing partially covers the engaging portion (7) of the second housing. As a result, it is possible to prevent disengagement due to vibrations or impacts. The operation is the same when not using a conductive shell in the present embodiment.

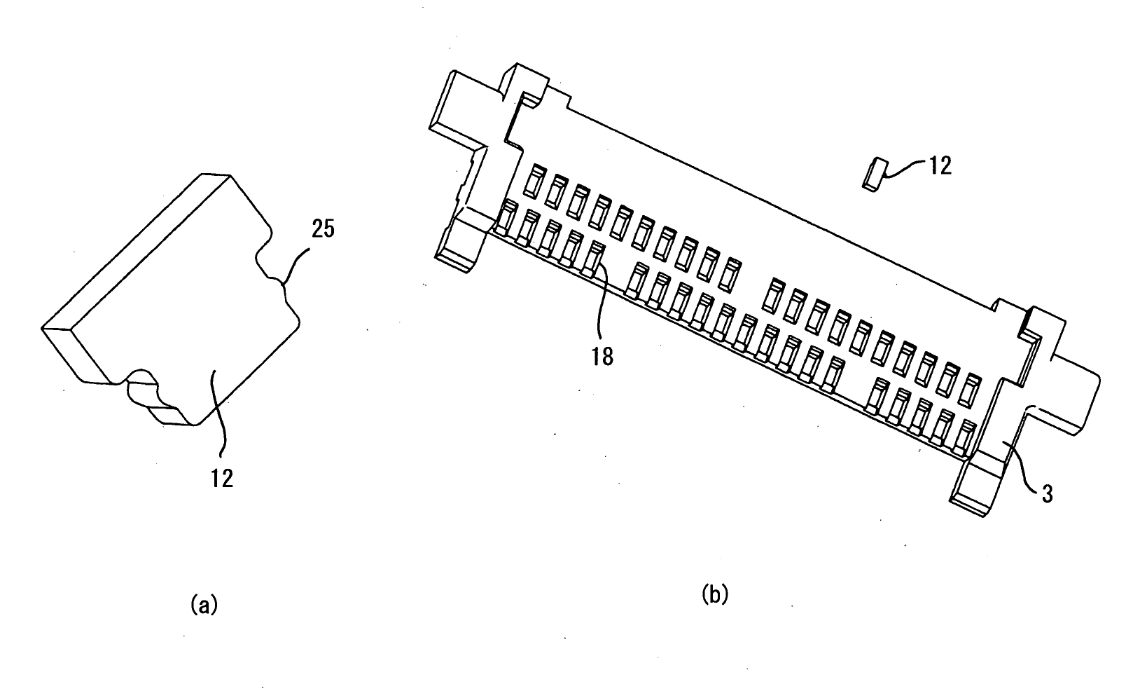

Additionally, the connector of the present invention has a structure that simplifies the positioning of connectors and allows for reliable fitting when fitted together. FIG. 4 shows an example thereof. FIG. 4 is a section view of FIG. 3(b). As seen in the drawing, positioning recesses (21) are formed in the first housing (3), and positioning bumps (19) to be received in these recesses are formed in the second housing (21). When the first and second connectors are fitted together, the bumps (19) are received in the recesses (20). As a result, the connectors can be positioned, and it is possible, for example, to restrict misalignments when fitting the connectors together, thus preventing damage to the contacts and contact portions (not shown in the present drawing). However, the present embodiment is not limited to the above, and the recesses and bumps may be reversed. That is, the bumps may be formed on the first housing (3) side and the recesses formed on the second housing (21) side.

Finally, FIG. 5 is a section view of the connector after fitting. As seen in this drawing, the positioning bumps (19) of the second housing (21) are received in the corresponding recesses (20) of the first housing (3). Additionally, (16) and (17) face in opposite directions, in other words are inverted, and contact the bottom surfaces (15) of the contact portions (12). Additionally, the top surfaces (14) of the contact portions (12) contact the anisotropic conductive film (13).

The connector of the present invention achieves an electrical connection between the top surface and the bottom surface of a first housing by insertion of separately formed contact portions into through holes of the first housing. As a result, a higher density connector can be produced by making the contact portions smaller. Furthermore, using an anisotropic conductive film allows high precision electrical connections to be made. Additionally, since the contacts are able to be formed at high density as described above, electrical connections must be reliably achieved when fitting the connectors together, but the present invention achieves this by positioning recesses and bumps formed on the first and second housing, and tapers or steps formed in the areas around the openings of the through holes in the first housing, thus allowing the contacts and contact portions to be reliably brought into contact. Additionally, an engaging portion of the second housing has a structure such as to partially cover an engaging portion of the first housing or conductive shell which is the engaging portion of the first connector, thus enabling the engagement to be maintained even when vibrations or impact are applied.

1. A first connector which is an electrical connector, comprising a first housing having contact portions, achieving an electrical connection by one of the end portions of said contact portions contacting an anisotropic conductive film, and the other end portions contacting terminals provided on the second housing.

2. A first connector in accordance with claim 1, wherein said contact portions are formed separately.

3. A first connector in accordance with claim 1, wherein said first housing has through holes for receiving said contact portions.

4. A first connector in accordance with claims 1, wherein said through holes are positioned in a staggered fashion.

5. A first connector in accordance with claim 1, wherein said first housing has a conductive shell, said shell connected to a shield portion of a conductor contacting said anisotropic conductive film.

6. A first connector in accordance with claim 1, wherein the first connector has recesses or bumps that fit with a second connector.

7. A second connector comprising a second housing affixed to a substrate, said second housing fitting with a first connector in accordance with claim 1 and having contacts, and said contacts being oriented in a mutually inverted relationship with adjacent contacts.

8. A second connector in accordance with claim 7, wherein said second connector has an engaging portion for engaging with the first connector on at least one end in the direction of insertion of the first connector.
